(19) United States
(12) Patent Application Publication
(10) Pub. No.: US 2002/0008071 A1
(43) Pub. Date: Jan. 24, 2002

(54) Environmental filter and flow control device

(76) Inventor: Andrew W. Chinn, Grove City, OH (US)

Correspondence Address: STANDLEY & GILCREST LLP, 495 METRO PLACE SOUTH, SUITE 210, DUBLIN, OH, 43017, US

(21) Appl. No.: 09/900,271

(22) Filed: Jul. 6, 2001

Related U.S. Application Data
(60) Provisional application No. 60/216,073, filed on Jul. 6, 2000.

(51) Int. Cl. C02F 1/00

(52) U.S. Cl. 210/767; 210/660; 210/747

(57) ABSTRACT

The present invention is to a method of filtering, blocking, altering, removing and/or redirecting the flow and movement of contaminants in the environment. The invention also encompasses a structure used to accomplish the above-mentioned method. The invention, in particular, includes a structure used to enclose a straw bale or bales and may additionally include absorbents or other additives to enhance pollution control.

This application claims the priority of U.S. Provisional Application Ser. No. 60/216,073, filed Jul. 6, 2000.

### BACKGROUND AND SUMMARY OF THE INVENTION

The present invention relates generally to a system for use in controlling and modifying the environmental impact of a wide variety of environmental measures, methods and conditions, and more particularly to a method and apparatus for changing the properties of such measures, methods and conditions through filtering and/or control of flow, such that the end result is a more advantageous environmental outcome. The device may, for example, redirect water flow or filter constituents from flowing water, although the invention is not limited to these activities.

In recent years, federal, state and local governments have placed legislative and regulatory controls on a wide variety of sources of pollution and on the conditions that lead to instances of pollution and contamination. In response to these governmental mandates, environmental control measures are routinely implemented in a wide variety of circumstances, ranging from construction sites and manufacturing plants to mining operations and waste disposal sites and many others. These environmental control measures produce certain results, depending upon the nature and effectiveness of the control measure and the circumstances of its implementation. For example, certain erosion control measures can reduce the silt and sediment content of storm-water runoff, or spill containment measures can reduce the amount of certain contaminants that enter the water or soil in the case of a chemical spill. The environmental effectiveness of the results accomplished by these measures can vary, depending on a number of factors relating to the measure itself and to the circumstances of its implementation.

In other situations, environmental conditions are monitored in response to governmental mandates, but specific environmental measures are not implemented unless certain environmental parameters are met or exceeded. The efficacy of these measures and of this monitoring approach in achieving environmental results also varies significantly.

The present invention is designed to change the results of these environmental control measures or environmental monitoring and to improve the environmental effectiveness of these activities by altering the way in which these measures are implemented. The present invention improves the effectiveness and results of a wide range of measures, and does so in a manner that is easy to implement and maintain. The present invention accomplishes this improvement through a variety of methods involving environmental filtering and/or control of flow, and it may be constructed in a variety of ways, singularly or in combination to achieve this improvement of the effectiveness of the environmental control measure or monitoring.

The present invention is designed to filter, block, alter, remove or redirect the flow and movement of contaminants of various types and concentrations. The present invention accomplishes these actions by changing the result of environmental control measures or monitoring through the addition of a structure added to the control measure or monitoring, that provides filtering, removal of constituents, redirection or obstruction of flow. The present invention comprises numerous forms, structures and variations as needed to successfully adapt to a wide variety of environmental conditions and environmental control measures.

The present invention may be constructed of a variety of materials, including, but not limited to, fabric of various characteristics, absorbents, plastics, rubber, metals or any substance or combination of substances that may filter, impede, absorb, re-direct or obstruct flow. These materials may take the form of panels, although such is not required. The present invention may take any shape as needed for the pertinent environmental conditions. The present invention may be supported by an outer or inner structure of material of any type, as described above, however support of this type is not required, depending on the environmental measure to which the present invention is applied and depending on the surrounding conditions. The environmental control measure may be partially or completely covered or blocked by the structure of the present invention, however the present invention may be separated completely or in part from the environmental measure.

The present invention may comprise a structure(s) that is constructed singularly or in combination. The present invention may be secured by any means ranging, without limitation, from its own weight or the weight of its components, to clips, nails, staples or other fasteners to any other form of mechanical device or fastener. The present invention may be secured at various places within the structure of the invention or to other units of the invention, or to a land or water feature or other part of the environment.

The present invention also includes a method for changing the result of environmental control measures or monitoring through the addition of a structure added to the control measure or monitoring, that provides filtering, removal of constituents, or redirection or obstruction of flow. The method includes structures constructed of various materials, including, but not limited to, fabric of various characteristics, absorbents or other additives, plastics, rubber, metals or any substance or combination of substances that may filter, impede, absorb, re-direct or obstruct flow. The method also includes securing the structure, singularly or in combination, by any means including, without limitation, its own weight or the weight of its components, clips, nails, staples or other fasteners or any form of mechanical device or fastener. The method also includes securing the structure of the invention at various places within the structure of the invention or to other units of the invention, or to a land or water feature or other part of the environment.

As one of many embodiments of the invention, if the environmental control measure is a straw bale or straw bales, often used singularly or in combination to control storm-water runoff and reduce sedimentation, the invention may be constructed as a structure to enclose, or partially enclose these straw bales with fabric with properties that alter or effect the flow or composition of storm water or other runoff or contaminants associated therewith. The enclosing structure may improve the environmental control characteristics of the straw bales through the addition among other things, of structural integrity and superior environmental characteristics. In addition, in such an instance, the invention may employ absorbents or other additives to enhance the pollution control aspects of the straw bale environmental control measure. The present invention is, of course, not limited to this particular embodiment.

The present invention includes a method of filtering, blocking, altering, removing or redirecting the flow and movement of contaminants comprising: enclosing or partially enclosing an environmental control measure; placing the environmental control measure in an advantageous location in relation to the flow of the contaminants; and securing the enclosed or partially enclosed environmental control measure.

Contaminants may be any undesired substance in water or dirt. In particular, contaminants may be oil, chemicals, or debris. Environmental control measure includes any measure taken to improve the quality of the water or land. Particularly, an environmental control measure may be a straw bale. An advantageous location in relation to the flow of the contaminants may mean any location that will facilitate the filtering, blocking, altering, removing or redirecting of the flow of the contaminants. Particularly, the enclosed or partially enclosed environmental control measure will be placed downstream from the flow of contaminants. Securing the enclosed or partially enclosed environmental control measure may be accomplished by the weight of the environmental control measure alone, the weight of the environmental control measure with added components or may include clips, nails, staples or other fasteners or combinations thereof. Added components may include absorbents or any other components that would aid in the filtering, blocking, altering, removing or redirecting of the flow of contaminants.

Additional absorbents may be added to the enclosed or partially enclosed environmental control measure. The additional absorbents may be oil absorbents and may be absorbent pillows, socks or booms.

The present invention is also to an apparatus for filtering, blocking, altering, removing or redirecting the flow and movement of contaminants comprising at least one enclosed or partially enclosed environmental control measure.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a view of a single bale bag, in accordance with one embodiment of the present invention;

FIG. 2 is a view of a plurality of bale bags in accordance with one embodiment of the present invention.

### DETAILED DESCRIPTION OF THE EXEMPLARY EMBODIMENT(S)

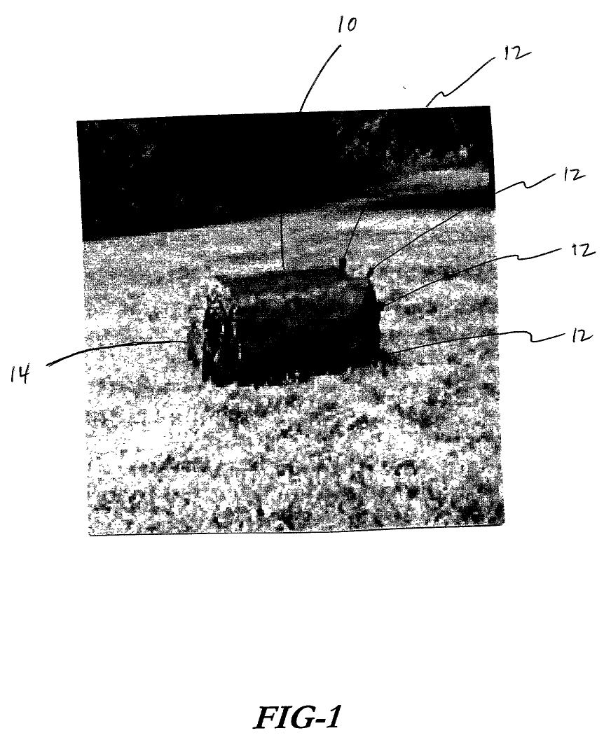

FIG. 1 shows the use of a single bale bag 10 of the present invention. The bag 10 may be used for filtration, flow control, structural purposes, and/or any other desired purpose. For example, the bag 10 may be used to block, absorb, redirect, slow down, and/or otherwise control the flow or a portion of the flow (e.g., silt, sediment, rocks, oil, water, and any other part of a flow). For another example, the bag 10 may be used to weight down an environmental control measure, provide rigidity to an environmental control measure, and/or to help maintain the position of an environmental control measure.

The bag 10 may be comprised of any material that is suitable for filtration, flow control, and/or structural purposes. For instance, the bag 10 may be comprised of: 1) a permeable mesh, screen, or grate material of any desired coarseness; 2) a permeable, relatively solid material; 3) an impermeable material; and/or 4) any other similar, suitable, or conventional material. Examples of suitable materials include, but are not limited to, geosynthetic materials, geotextile materials, the material used to make the Silt Check™ (which is described in U.S. Pat. No. 5,632,888 and commercially available from Dandy Products, Inc.), the material used to make the Silt Fence™ (which is commercially available from Dandy Products, Inc.), fabrics (woven and non-woven), cloths (woven and non-woven), plastics, metals, cellulosic materials, and any other similar, suitable, or conventional material. The material may be natural or synthetic as well as virgin or recycled. In addition, the bag 10 may have a flexible or a rigid shape.

The bag 10 may be secured by its own weight, the weight of any material that is inside the bag 10, and/or fastening means. The bag 10 may optionally include one or more fastening means. The fastening means may be used to secure the bag 10 in position. In this example, the fastening means includes a plurality of retaining loops 12. Any suitable device (e.g., a stake, a pole, a weight, or any other similar, suitable, or conventional device) may be inserted through the retaining loops 12 to Jo help the bag 10 maintain its position. In addition or alternatively, the fastening means may include any other similar, suitable, or conventional device that may help the bag 10 maintain its position. Examples of other fastening means include straps, ropes, chains, hooks, weights, clips, nails, screws, staples, or any other fastener or combinations thereof.

If desired, the bag 10 may be filled with any suitable material. The filler material 14 may be used for filtration, flow control, and/or structural purposes. For example, the filler material 14 may be used to block, absorb, redirect, slow down, and/or otherwise control the flow or a portion of the flow (e.g., silt, sediment, rocks, oil, water, and any other part of a flow). For another example, the filler material may be used to weight down and/or provide rigidity to the bag 10 to help maintain the position of the bag 10. In this example, the filler material 14 is a bale of straw or hay. However, it should be recognized that any desired filler material 14 may be selected. Examples of filler material 14 include, but are not limited to, fibers, straw, hay, grass, leaves, cellulosic materials, plastic objects, tires, papers, fibrous materials, coir logs, pipes, rocks, soil, metal objects, absorbent articles (e.g., oil absorbent articles), and any other similar, suitable, or conventional material. The filler material 14 may be natural or synthetic as well as virgin or recycled. In addition, the filler material 14 may have any desired shape which may be a regular shape (e.g., a square, a rectangle, a circle, a polygon, a triangle, or any other similar, suitable, or conventional regular shape) or an irregular shape (e.g., a pile, a stack, a mound, or any other similar, suitable, or conventional irregular shape). If desired, the filler material 14 may be selected to have a desired shape or weight to help maintain the bag 10 in a desired position.

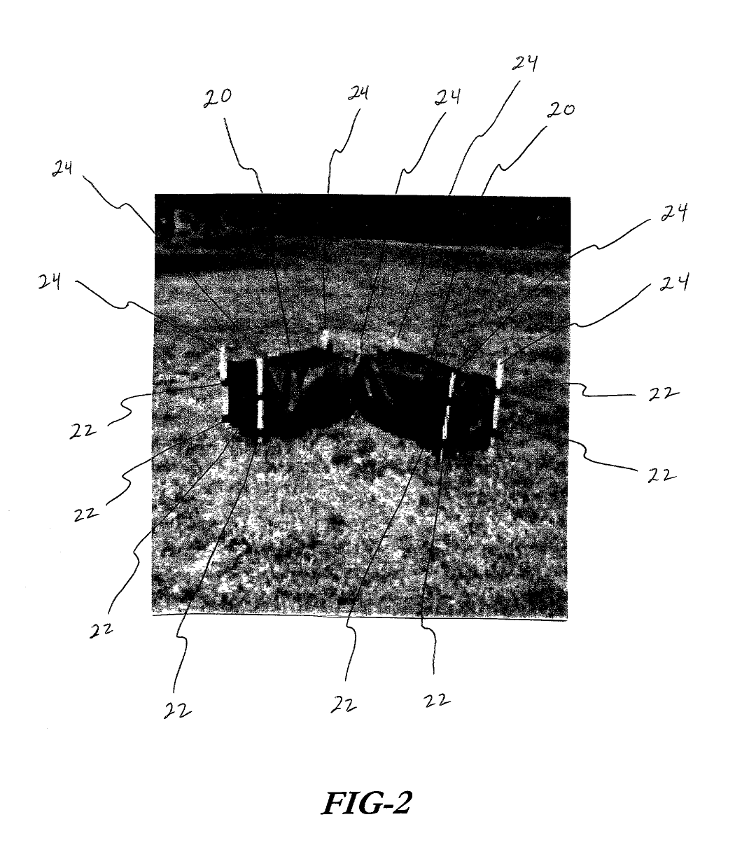

FIG. 2 shows a plurality of bale bags 20 of the present invention. The bale bags 20 may include any of the optional or preferred features of the above-described embodiment. In this example, straw bales are placed inside the bags 20. If desired, stakes 24 may be inserted through the retaining loops 22 and into the ground or another structure in order to help maintain the position of the bags 20. The bags 20 may be placed in any desired position for controlling the flow. For instance, the bags 20 may be placed in a straight line, a curved line, a line wherein the bags 20 are intersecting, a line wherein the bags 20 are staggered, or in any other desired formation. Also, the bags 20 may be stacked or placed at various angles. The number of bags 20 may be selected to suit the intended purpose. It should be recognized that a bag 20 may be used alone or in combination with other bags 20 to control the flow.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, it will be within the ability of one of ordinary skill in the art to make alterations or modifications to the present invention, such as through the substitution of equivalent materials so as to be able to practice the present invention without departing from its spirit as reflected in the appended claims, the text and teaching of which are hereby incorporated by reference herein. It is the intention, therefore, to limit the invention only as indicated by the scope of the claims and equivalents thereof.

What is claimed is:

1. A method for filtering, blocking, altering, removing or redirecting the flow and movement of contaminants comprising:
a. enclosing or partially enclosing at least one environmental control measure;
b. placing said at least one environmental control measure in an advantageous location in relation to the flow of the contaminants; and
c. securing the enclosed or partially enclosed at least one environmental control measure.

2. The method of claim 1, further comprising the addition of absorbents to the enclosed or partially enclosed at least one environmental control measure.

3. The method of claim 2 wherein said absorbents are oil absorbents.

4. The method of claim 2, wherein said absorbents are selected from the group consisting of oil absorbing socks, oil absorbing pillows and oil absorbing booms.

5. The method of claim 1, wherein said at least one environmental control measure is enclosed or partially enclosed with material, said material selected from the group consisting of geotextile fabric, plastic, rubber and metal or combinations thereof.

6. The method of claim 1, wherein said at least one environmental control measure is a straw bale.

7. The method of claim 1, wherein said at least one environmental control measure is secured by a method selected from the group consisting of the weight of said environmental control measure alone, the weight of said environmental control measure with added components, clips, nails, staples, and other fasteners or combinations thereof.

8. An apparatus for filtering, blocking, altering, removing or redirecting the flow and movement of contaminants comprising at least one enclosed or partially enclosed environmental control measure.

9. The apparatus of claim 8, wherein said environmental control measure is a straw bale.

10. The apparatus of claim 8, further comprising an absorbent selected from the group consisting of oil absorbing socks, oil absorbing pillows and oil absorbing booms.

11. The apparatus of claim 8, wherein said at least one enclosed or partially enclosed environmental control measure is enclosed or partially enclosed with material, said material selected from the group consisting of geotextile fabric, plastic, rubber and metal or combinations thereof.

12. The apparatus of claim 8, wherein said at least one enclosed or partially enclosed environmental control measure is secured by a method selected from the group consisting of the weight of said at least one enclosed or partially enclosed environmental control measure alone, the weight of said at least one enclosed or partially enclosed environmental control measure with added components, clips, nails, staples, and other fasteners or combinations thereof.

13. The apparatus of claim 8, wherein said environmental control measure is enclosed or partially enclosed with material, said material selected from the group consisting of geotextile fabric, plastic, rubber and metal or combinations thereof.

14. A method for filtering, blocking, altering, removing or redirecting the flow and movement of contaminants comprising:
a. enclosing or partially enclosing at least one straw bale;
b. placing said at least one straw bale in an advantageous location in relation to the flow of said contaminants; and
c. securing the enclosed or partially enclosed at least one straw bale.

15. The method of claim 14, further comprising an absorbent added to the at least one straw bale.

16. The method of claim 15, wherein said at least one straw bale is enclosed or partially enclosed with material, said material selected from the group consisting of geotextile fabric, plastic, rubber and metal or combinations thereof.
